(19) United States
(12) Patent Application Publication
(10) Pub. No.: US 2025/0110767 A1
(43) Pub. Date: Apr. 3, 2025

(54) DETECTING MISCONFIGURATION OF VIRTUAL RESOURCES

(71) Applicant: Microsoft Technology Licensing, LLC, Redmond, WA (US)

(72) Inventors: Scott Gregory WASSON, Millbury, MA (US); Bhaskar Rao AMBEKAR, Westford, MA (US)

(21) Appl. No.: 18/479,041

(22) Filed: Sep. 30, 2023

(51) Int. Cl. G06F 9/455

(52) U.S. Cl. CPC G06F 9/45558; G06F 2009/4557; G06F 2009/45595

(57) ABSTRACT

The present disclosure relates to systems, methods, and computer-readable media for determining whether a pinning misconfiguration exists between one or more virtual cores (e.g., vCPUs) and physical cores on a computing device. In particular, the present disclosure involves virtual cores of an application or cloud-based service (e.g., a virtual machine) that runs machine loops on bursts of data packets that are assigned to the virtual core(s) and determines whether a delay has occurred in processing the packets. Based on this delay, the disclosure discusses determining whether a pinning misconfiguration exists as a result of the physical core being mistakenly over-allocated to multiple virtual cores by the hypervisor of the computing device.

### BACKGROUND

Cloud computing involves the delivery of computing services over the Internet. Some examples of computing services that can be provided by a cloud computing system include storage, databases, networking, software, telecommunications, and analytics. The use of cloud computing technology has grown rapidly in recent years, due at least in part to the development of high-capacity networks as well as relatively low-cost computers and storage devices.

Cloud computing systems enable users, businesses, and other entities access to a significantly enhanced quantity of computing resources, reducing the need for large, up-front capital expenditures. With many public cloud computing providers, clients can choose to scale resources up or down. While this flexibility in capacity provides ready availability to a large number of users, it does create some problems in predicting the number of resources that need to be allocated at any given time to certain users and applications. Many cloud computing systems attempt to accommodate unpredictable and variable workloads by provisioning services, such as virtual machines, in a way that allows the services to share computing resources. Indeed, many server devices can be configured to accommodate a large number of virtual machines by allowing physical cores and other hardware resources to be shared between multiple services.

While provisioning services in this manner enables a cloud computing system to host a larger quantity of services on a fewer number of server nodes, there are some applications that rely on ready availability of computing resources and have low tolerance for delays that often accompany sharing physical resources between virtual services (e.g., virtual machines, virtual cores). By way of example, and as will be discussed in further detail herein, many packet processing applications rely heavily on ready-availability of physical computing resources (e.g., compute cores) to process large quantities of data packets over short periods of time. Indeed, if these applications begin sharing computing resources while receiving a burst of packets, these packets or often dropped and communication of data will quickly break down.

These and other problems exist in connection with hosting a variety of services (e.g., packet processing applications) in a computing environment, such as a cloud computing environment.

### BRIEF DESCRIPTION OF THE DRAWINGS

FIG. 1 illustrates an example environment of a cloud computing system in which a virtual machine configuration management system manages configurations of server nodes across a plurality of node clusters.

FIG. 2A illustrates an example server node having a virtual core delay detection system implemented thereon in accordance with one or more embodiments.

FIG. 2B illustrates an example deployment of virtual machines and affinity between virtual computing processing units (vCPUs) and physical cores on a computing device in accordance with one or more embodiments.

FIG. 3 illustrates an example workflow in which virtual core delay detection system facilitates detection of processing delays on vCPUs in accordance with one or more embodiments.

FIG. 4 illustrates an example series of acts that may be performed by a virtual core in detecting a processing delay and potential pinning misconfiguration in accordance with one or more embodiments.

FIG. 5 illustrates a series of acts for detecting one or more pinning misconfigurations in computing environment in accordance with one or more embodiments.

FIG. 6 illustrates certain components that may be included within a computer system.

### DETAILED DESCRIPTION

The present disclosure is generally related to detecting delays in processing data that are indicative of a hypervisor misconfiguring one or more services, such as a virtual machine or specific virtual core(s) on the virtual machine(s). In particular, the systems described herein facilitate detecting delays in processing packets (e.g., data packets) received at a computing device and determining, based on the detected delays, that a pinning misconfiguration likely exists between one or more virtual cores (e.g., vCPUs) and compute cores (e.g., physical cores) on a computing device.

By way of example, and as will be discussed in further detail below, this disclosure describes a computing device (e.g., a server node) having a hypervisor for managing configurations of virtual machines and corresponding virtual cores (vCPUs) and which detects pinning misconfigurations by the hypervisor in the computing device. In one or more implementations, a virtual machine (or other container, thread, or application) receives a plurality of data packets (or simply “packets”) to be processed by computing resources allocated to the virtual machine. The packets are assigned to a virtual core being associated with a physical core of the computing device. The virtual machine (e.g., the virtual core) runs a machine loop on the plurality of packets to process the plurality of packets and tracks a duration of time associated with running the machine loop on the packets. Based on a comparison of the duration of time with an estimated duration of time of processing the packets, a pinning misconfiguration is be determined or otherwise predicted to exist between the virtual core and the computing resource(s).

The present disclosure includes a number of practical applications that provide benefits and/or solve problems associated with detecting delays in processing packets in applications in which high affinity between virtual and physical resources is presumed or expected. Examples of these applications and benefits are discussed in further detail below.

As will be discussed in further detail below, a virtual core delay detection system (or simply “delay detection system”) provides features and functionality that enable a virtual machine or virtual core to quickly and accurately detect latency issues within a service that may be causing dropped packets. Indeed, by applying a machine loop on a received set of packets and tracking a duration of time associated with running the machine loop in processing the received packets, the delay detection system can determine whether the tracked duration of time is within an expected duration of time or greater than an expected duration of time that the virtual core would be expected to process the packets. Because duration of time is highly predictable in an environment in which high affinity between virtual and physical resources exists, durations of time can be reliably detected and latency issues may be diagnosed in a quick and effective manner.

In addition to providing a quick and effective approach to detecting processing delays, the delay detection system provides a scalable approach to determining latency issues across a large number of virtual cores. For example, by tasking the virtual core(s) (e.g., software threads) to individually detect delays, any number of virtual cores across multiple virtual machines can simultaneously detect delays and provide an accurate picture of a zone or region of devices (e.g., a cluster, a rack, a datacenter) that may be experiencing similar types of delays. Indeed, by allowing a thread itself to detect the delay, this can be performed in a manner that adds very little processing overhead to the cloud computing system.

By detecting these delays and providing an indication of the specific virtual cores and/or devices on which the delays are happening, the delay detection system provides a convenient solution for administrators of cloud computing systems to determine specific devices or zones of devices that need to be reconfigured. In conventional approaches, pinning misconfigurations are diagnosed based on observed rates with which packets are dropped, but with limited information as to why the packets were being dropped, which could be for a variety of reasons. As a result, conventional detection approaches are time consuming and delays can go on for weeks without an administrator knowing where the misconfigurations are happening. The present disclosure provides a much more efficient approach to identify a specific type of problem based on identified processing delays, namely delays in processing packets caused as a result of pinning misconfigurations between virtual and physical resources.

The delay detection system provides a flexible approach that may be selectively applied to services for which high affinity between virtual and physical resources are expected or guaranteed. Thus, features of the delay detection system may be applied in a way that does not result in a negative impact on overall utilization of cloud computing resources by effectively preventing hypervisors from efficiently managing or otherwise optimizing computing resources. Indeed, where certain services have a high tolerance for sharing computing resources, the delay detection system does not prevent the hypervisor from optimally allowing these services from sharing physical computing resources on server nodes.

The systems described herein are additionally applicable to a variety of cores and a variety of applications or services. For example, while one or more implementations described herein relate specifically to data plane development kit (DPDK) P-threads (POSIX threads) or DPDK applications that are tasked with processing incoming packets, the features and functionalities described herein may be applied to different types of virtual cores (e.g., handler virtual cores, input/output (I/O) virtual cores) and may be applied to any of a variety of services or applications that benefit or are generally configured to have a high affinity between virtual and physical resources. Indeed, features of the delay detection system described in connection with DPDK applications may be applied to any service or application having a quality of service (QOS) guarantee or other expectation in which a threshold affinity between physical and virtual resources is expected (e.g., a 1:1 pinning between a vCPU and a physical core).

As illustrated in the foregoing discussion, the present disclosure utilizes a variety of terms to describe features and advantages of the systems herein. Additional detail is now provided regarding the meaning of some example terms.

For example, as used herein, a “cloud computing system” or simply “cloud” refers to a network of connected computing devices that provide various services to customer devices (e.g., client devices, network devices). For instance, as mentioned above, a distributed computing system can include a collection of physical server devices (e.g., server nodes) organized in a hierarchical structure including clusters, computing zones, virtual local area networks (VLANs), racks, fault domains, etc. The cloud computing system may refer to a private or public cloud computing system. In one or more embodiments described herein, a computing device or host device refers to a server node or any network device on a cloud computing system.

As used herein, a “virtual machine” refers to an emulation of a computer system on a server node that provides functionality of one or more applications or services on the cloud computing system. Virtual machines can provide functionality needed to execute one or more operating systems. In addition, virtual machines can make use of hypervisors on processors of server devices that support virtual replication of hardware. For example, in one or more embodiments described herein, the hypervisor manages virtual cores (e.g., vCPUs) and associated physical cores on a server node by pinning virtual cores to corresponding physical cores and facilitating usage of the physical computing resources of the computing device by the virtual machines and associated virtual cores. As noted above, in one or more implementations, this involves a 1:1 pinning between virtual and physical resources to emulate dedicated hardware for a particular thread. Nevertheless, as will be discussed below, this may also involve the hypervisor facilitating a sharing of physical resources between different virtual machines and/or between different virtual cores of the same or across different virtual machines.

As used herein, “configuration data,” a “machine configuration,” or “hardware configuration” may refer to specifications or characteristics associated with operation of any service on a computing device. For example, configuration data may refer to any information or instructions that the virtual machine may implement in performing various tasks in connection with data or other computing resources maintained on a computing device. As used herein, a configuration may refer interchangeably to a configuration of a hypervisor and/or subsequent service. In one or more embodiments described herein, the configuration specifically refers to management of accessibility to physical resources by corresponding virtual cores on a server node.

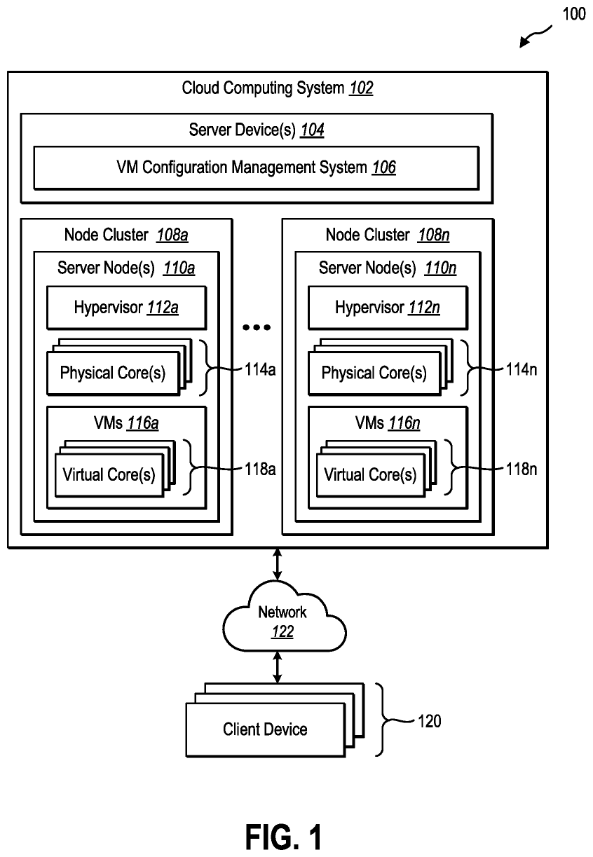

Additional detail will now be provided regarding examples of systems and components in relation to illustrative figures portraying example implementations. For example, FIG. 1 illustrates an example environment 100 including a cloud computing system 102. The cloud computing system 102 may include any number of devices. For example, as shown in FIG. 1, the cloud computing system 102 may include one or more server device(s) 104 having a virtual machine (VM) configuration management system 106 (or simply “configuration management system 106”) thereon. As will be discussed below, the configuration management system 106 may be tasked with deploying, modifying, updating, deleting, or otherwise managing configurations (e.g., hypervisor configurations, VM configurations) across a number of server nodes on the cloud computing system 102. In some examples described herein, the configuration management system 106 collects data (e.g., detected processing delay data) and fixes, updates, or otherwise modifies configurations based on delays in processing that are detected by virtual core delay detection system(s) implemented across any number of server nodes.

In addition to the server device(s) 104, the cloud computing system 102 may include any number of computing devices distributed across computing zones. In this example, the cloud computing system 102 includes a plurality of node clusters 108a-n. The node clusters 108a-n may be grouped by geographic location (e.g., a physical grouping of devices within a datacenter). Alternatively, one or more of the node clusters 108a-n may be implemented across different geographic locations (e.g., on different server racks within a datacenter or across multiple datacenters).

As shown in FIG. 1, the node clusters 108a-n may have server node(s) 110a-n implemented thereon. The node clusters 108a-n may have any number of server nodes. In some implementations, different node clusters 108a-n have different quantities of nodes. For example, a first node cluster 108a may include a first plurality of server node(s) 110a, which may refer to a variety of computing devices or network devices that are connected with other devices within the framework of the cloud computing system 102.

As shown in FIG. 1, an example server node includes a hypervisor 112a and a plurality of physical cores 114a. The server node may include any number of physical cores 114a as may serve a particular implementation. The number of physical cores 114a may be different from node to node. The one or more of the physical cores may be allocated as available resources to any number of services (e.g., virtual machine(s) 116a) that are hosted by the server node(s) 110a.

The first node cluster 108a and server node(s) 110a are provided by way of example and are not intended to be limiting in the features and functionalities of the remaining node clusters and associated devices. Indeed, each of the node clusters 108a-n may have different numbers of server nodes and may be configured in a similar or different manner as devices on the first node cluster 108a. Thus, while one or more embodiments described herein are discussed in connection with a single server node, features described in connection with these examples may be applicable to any number of server nodes and node clusters on the cloud computing system 102.

As shown in FIG. 1, each of the server nodes 110a-n include one or more virtual machines 116a-n. For instance, a first server node(s) 110a may include a first set of virtual machine(s) 116a implemented thereon. The set of virtual machine(s) 116a may include multiple virtual machines of similar types (e.g., that provide similar services or have similar virtual machine configurations). Alternatively, the virtual machine(s) 116a may include virtual machines of different types and operating in accordance with different hypervisor configurations and different virtual machine configurations. Each of the virtual machines 116a-n may have similar features and functionality as the first set of virtual machine(s) 116a on the first server node(s) 110a.

As further shown, each of the virtual machines 116a-n include one or more virtual cores 118a-n thereon. Different virtual machines 116a-n may have different numbers and specifications of virtual cores associated therewith. For example a larger virtual machine may include a number of virtual cores corresponding to a number of physical cores that are implemented on the server nodes such that the virtual machine is the only (or one of a few) virtual machines implemented on the respective server node. Alternatively, in one or more implementations, a server node may include multiple virtual machines having a fewer number of virtual cores than the total number of physical cores available on the server node. In other implementations, the virtual cores across one or multiple virtual machines may outnumber the total number of physical cores, such as in the event that the virtual machines (or virtual cores) are configured to share processing resources with other virtual machines (or other virtual cores).

In addition to the cloud computing system 102 and associated components, the environment 100 may include a plurality of client devices 120 in communication with the cloud computing system 102 via a network 122. For example, the client devices 120 may communicate with the server nodes 110a-n via the network 122. The client devices 120 may refer to various types of computing devices including, by way of example, mobile devices, desktop computers, server devices, or other types of computing devices. The network 122 may include one or multiple networks that use one or more communication platforms or technologies for transmitting data. For example, the network 122 may include the Internet or other data link that enables transport of electronic data between respective client devices 120 and devices of the cloud computing system 102. In one or more embodiments, the network 122 refers to a mobile communication network (e.g., a 5G mobile communication network), such as a radio access network (RAN) and core network that provide a series of functions that facilitate communications with data and services hosted by the server nodes 110a-n of the cloud computing system 102.

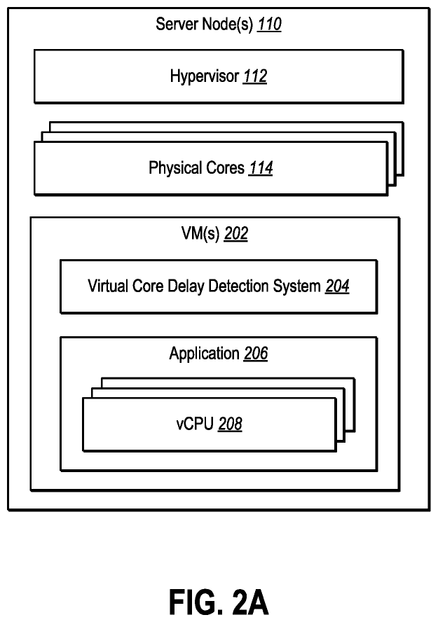

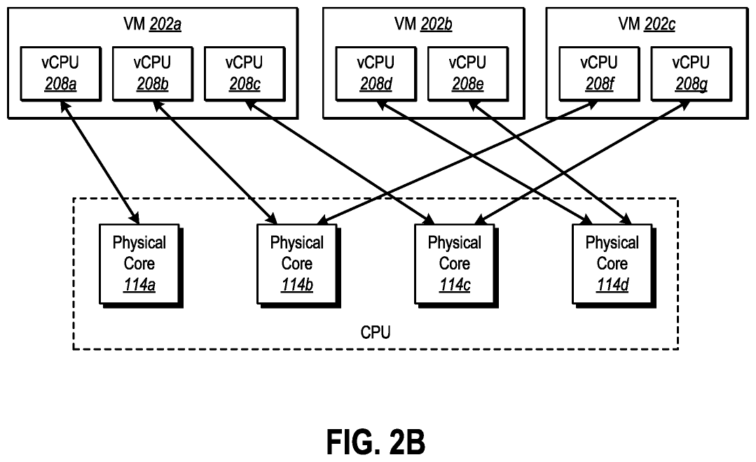

Additional detail will now be discussed in connection with an example server node having a plurality of virtual machines and a virtual core delay detection system (or simply “delay detection system”) implemented thereon. For example, FIG. 2A illustrates a server node 110 including a hypervisor 112 and physical cores 114 having similar features and functionality as similarly named components discussed above in connection with FIG. 1.

As further shown, the server node 110 includes a plurality of virtual machines 202 (referred to individually or collectively as “VM 202”). As shown in FIG. 2A, the VM 202 (e.g., each of multiple VMs) includes a virtual core delay detection system 204 (or simply “delay detection system 204”). The VM 202 additionally includes an application 206 having a plurality of vCPUs 208 running thereon. The application 206 may refer to a variety of applications that can be hosted by the VM 202 (or other cloud computing service(s)). For ease in explanation, one or more implementations described herein specifically refer to a DPDK application running one or more P-Threads. The vCPUs 208 may be assigned to the respective P-Threads. The vCPUs 208 may also be pinned to corresponding physical cores 114 on the server node 110.

As will be discussed in further detail below in connection with various examples, the delay detection system 204 may be configured to detect a delay in processing with respect to one or more of the vCPUs 208 and/or the VM 202. In one or more embodiments, the delay detection system 204 runs as part of a thread in the vCPUs 208 to determine whether each vCPU is processing a packet or set of packets within a predicted period of time based on an assumption that the vCPU is pinned (e.g., exclusively pinned without sharing with other vCPUs) to a corresponding physical core from the plurality of cores 114 on the server node 110.

As shown in FIG. 2A, the delay detection system 204 may be implemented as part of a VM 202 and may be configured to perform any of the features and functions described herein as they relate to detecting a delay in processing a packet or set of packets. While FIG. 2A shows the delay detection system 204 as a separate component within the VM 202, in one or more embodiments, the delay detection system 204 is implemented within the application 206 and/or as part of the vCPUs 208 themselves. Thus, while one or more embodiments described herein refer to a VM 202 or other service performing the features and functionality of the delay detection system 204, it will be appreciated that the application 206 may carry out the features of the delay detection system 204 and/or the specific vCPUs 208 may carry out the features of the delay detection system 204. In one or more embodiments, the delay detection system 204 runs as a background process on the server node 110 in conjunction with the processes performed by the vCPUs 208.

Referring back to FIG. 1, the delay detection system 204 may cooperate with the configuration management system 106 to facilitate reconfiguration of various VMs and/or hypervisors based on detected delays. For example, where hypervisors are often deployed in a uniform manner to a grouping of server nodes (e.g., a node cluster, server rack), the configuration management system 106 may receive information about detected delays on respective server nodes from the delay detection system 204. Based on the delay information, The configuration management system 106 may identify specific devices or groupings of devices as well as specific VM configurations, VM types, and/or hypervisor configurations that are not operating as intended. This can pinpoint specific VMs, devices, and/or hypervisors that need to be monitored and/or fixed using any of a variety of mitigation actions.

Referring now to FIG. 2B, this figure illustrates an example configuration showing example pinnings between the cores 114 and the vCPUs 208 shown in FIG. 2A. As discussed above, these CPU pinnings may be performed by the hypervisor when creating or otherwise implementing a configuration of the VMs 202. More specifically, as shown in FIG. 2B, the plurality of VMs includes a first VM 202a, second VM 202b, and a third VM 202c. Each of the VMs 202a-c include one or more vCPUs. For example, the first VM 202a includes a first vCPU 208a, a second vCPU 208b, and a third vCPU 208c. The second VM 202b includes a fourth vCPU 208d and a fifth vCPU 208e. The third VM 202c includes a sixth vCPU 208f and a seventh vCPU 208g. The number of VMs and vCPUs per VM are provided by way of example and not limitation as they are intended to illustrate features of the delay detection system 204 described herein.

As further shown, the server node 110 includes a plurality of cores. In this example, the server node 110 includes a multi-core CPU including a first core 114a, second core 114b, third core 114c, and a fourth core 114d. As shown in FIG. 2B, the hypervisor may establish pinnings or bindings between the vCPUs and respective cores. In this example, one or more of the cores are pinned to multiple vCPUs while at least one core is pinned to a single vCPU. This 1:1 or 1:2 pinning may be based on specifications of the VMs and/or a configuration of the hypervisor in determining an affinity level for the vCPUs and/or VMs.

In one or more embodiments, this configuration of pinnings between the vCPUs and cores is a result of a misconfiguration of the hypervisor. By way of example, in one or more embodiments, each of the VMs 202a-c may have a requirement or QoS that guarantees ready availability of a physical core for each of the vCPUs thereon. Thus, the installation of multiple VMs with a collective total of vCPUs exceeding the number of physical cores causes a potential problem in which the hypervisor has over-provisioned the vCPUs on the server node.

While this overprovisioning is a desirable feature with some VMs and/or some applications that have a tolerance for a small amount of delay, this can be a significant problem when running DPDK applications that assume a 1:1 pinning between vCPUs and physical cores. Thus, where any one of the VMs 202a-c are running DPDK applications and where any of the vCPUs that are associated with the same physical core both need computing resources at the same time, the delay detection system 204 may detect unwanted delays where the hypervisor 112 is causing multiple vCPUs to share computing resources of a single core.

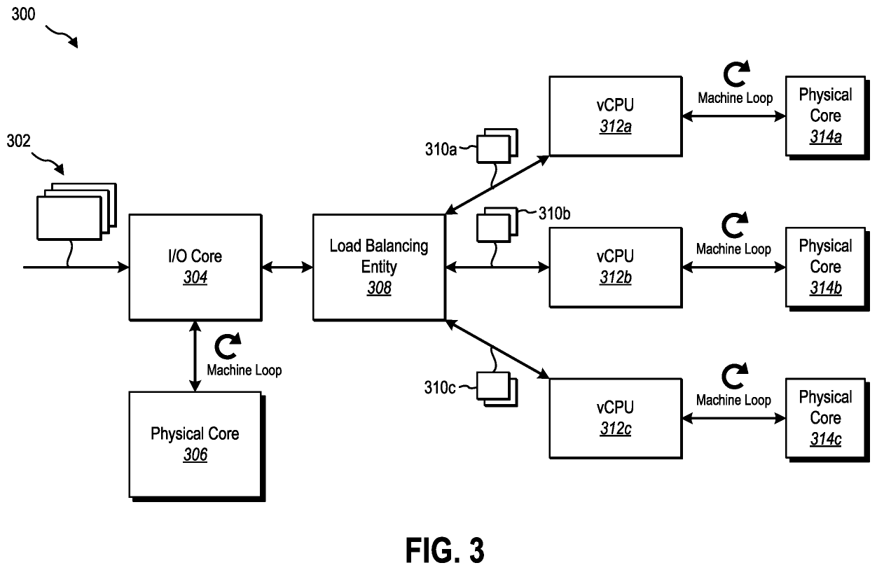

FIG. 3 illustrates an example workflow showing a mechanism with which the delay detection system 204 detects processing delays in a VM environment. More specifically, FIG. 3 illustrates an example VM environment including a plurality of virtual cores that cooperatively perform processing of incoming packets in a DPDK application. It will be understood that while FIG. 3 provides an example workflow including I/O cores (e.g., I/O virtual cores), a load balancing entity, and vCPUs that cooperatively process and communicate packets in accordance with one implementation, other implementations of both DPDK threads may utilize different methods and workflows for collecting packets, distributing packets, and processing packets. Moreover, as noted above, while this example involves detecting packet processing delays in a DPDK application, the delay detection system 204 may be deployed within any of a variety of VMs and other services having a variety of frameworks for processing and/or communicating packets between components of the cloud computing system.

As shown in the example of FIG. 3, a packet burst 302 is received at an I/O core 304. As used herein, a packet burst may refer to a collection of data packets that are received within a brief period of time. Indeed, as packets are often communicated sporadically with some low volume periods in which few (if any) packets are being transmitted and processed, there are also high-volume periods in which data packets are received in high volumes that are transmitted and processed within brief periods of time. In this example, a burst refers to a collection of packets received within a duration of time.

In this example, the I/O core 304 refers to a virtual I/O core hosted by a VM or other service. Pinned to the I/O core 304 is a physical core 306 that provides hardware resources to the I/O core 304. In this example, the VM is shown as having a single I/O core. Other implementations may include multiple I/O cores (e.g., two, three, or more) that are tasked with receiving packets and, after processing, outputting processed packets.

The I/O core 304 may receive the packet burst 302 in a variety of ways. In one example, the I/O core 304 communicates with a driver (e.g., a poll mode driver (PMD)) and requests up to a threshold number of packets or memory buffers (e.g., 16, 32, 64 packets) at regular intervals. In many cases, the driver does not have any packets to communicate, and the I/O core 304 responds by waiting a cycle and again requesting any number of available packets for processing up to a threshold.

As shown in FIG. 3, the I/O core 304 and associated physical core 306 utilize a machine loop. In one or more embodiments, the machine loop is associated with a threshold number of packets that the I/O core 304 is configured to process over a duration of the machine loop (e.g., an iteration of the machine loop). In this example, the I/O core 304 may log a period of time that it takes to receive and process the packets prior to feeding the packets to a load balancing entity 308. In particular, the I/O core 304 may determine a number of packets received in the packet burst 302 (e.g., 32 packets) and determine whether a tracked duration of processing the packets falls within an expected range of time. In this example, the machine loop for I/O cores will be a very deterministic duration, meaning that the period of time that it takes to process the burst of packets should fall within a specific range of time.

It will be understood that the expected range of time will differ based on the number of packets that are processed for a given machine loop. For example, processing a burst of eight packets will take less time than processing a burst of thirty-two packets (or other larger quantity of packets). Nevertheless, in each of these examples, the difference between the estimated processing time and the tracked processing time should fall within a close range.

In one or more embodiments, the physical resources that are allocated to the I/O core 304 (e.g., the physical core 306) may be re-allocated by the hypervisor for other processes within the same or different VM(s). In this event, the I/O core 304 may note that the tracked duration of time significantly exceeds the expected duration of time for processing the packets. Based on this difference, the I/O core 304 may determine that a delay has occurred, which may cause the core delay detection system 204 to log, report, or otherwise indicate the delay experienced by the I/O core 304.

As noted above, the I/O core 304 provides burst of packets to the load balancing entity. The load balancing entity 308 may refer to a variety of functions, devices, or components capable of distributing subsets of packets 310a-c from the packet burst 302 to a plurality of vCPUs 312a-c. In this example, the load balancing entity 308 may be referred generally as a load balancer. In other examples, the load balancing entity 308 may refer to a network interface controller (NIC), driver, or other component capable of distributing packets to respective destinations based on any number of criteria.

In this example, the load balancing entity 308 receives the burst of packets and makes load balancing decisions with respect to each of the packets. In one or more embodiments, the load balancing entity 308 scans the outer headers of the packets and makes a load balancing decision based on the outer headers. In one or more embodiments, the load balancing entity 308 makes a load balancing decision based on a current load of the vCPUs 312a-c. In one or more embodiments, the load balancing entity 308 performs a hashing operation (e.g., a five-tuple hash) to assure that a given flow of packets from a particular origin will go to the same vCPU.

As shown in FIG. 3, the load balancing entity 308 selectively delivers the packets by providing subsets of packets 310a-c (e.g., subsets of the packet burst 302) to each of multiple vCPUs 312a-c for processing. In this example, the vCPUs may refer to handler cores. Other types of cores may also be used. While FIG. 3 illustrates an example including one I/O core 304 and three vCPUs 312a-c, it will be appreciated that additional I/O cores and additional vCPUs may be present in different embodiments. Similar to the I/O core 304, the vCPUs 312a-c may be configured to process a threshold number of packets within a given processing cycle. The threshold number of packets may be a similar or different number of packets as other cores.

As shown in FIG. 3, each of the vCPUs 312a-c may be associated (e.g., pinned to) with corresponding physical cores 314a-c. In this example, a first vCPU 312a is pinned to a first physical core 314a, a second vCPU 312b is pinned to a second physical core 314b, and a third vCPU 312c is pinned to a third physical core 314c. As further shown, each of the vCPUs 312a-c may employ a machine loop in processing a given subset of packets and determining whether a tracked duration of time that it takes to process a given subset of packets is greater than an estimated period of time that the vCPU would be expected to process the given subset of packets.

Additional detail will now be discussed in connection with a first vCPU 312a and corresponding physical core 314a processing a first subset of packets 310a (e.g., load-balanced packets) and detecting whether a delay exists. The second and third vCPUs 312b-c and associated physical cores 314b-c may perform a similar mechanism for processing and detecting delays.

Similar to the I/O core 304 discussed above, the first vCPU 312a receives a set of packets and takes a timestamp. Taking the timestamp may involve reading a hardware register or otherwise requesting a clock value from the register. The vCPU 312a may also determine an estimated period of time based on a number of load-balanced packets received from the load balancing entity 308. The vCPU 312a may then proceed to use the computing resources of the physical core 314a to process the subset of packets 310a presumably within the threshold period of time (e.g., the estimated period of time based on the number of packets received at the vCPU 312a).

As discussed in one or more examples herein, the vCPU 312a may track a period of time that it takes to process the subset of packets 310a. For example, the vCPU 312a may again read the hardware register, request a clock value from the register, or otherwise take note of the timestamp at a time when the packet processing for the subset of packets 310a is complete. The vCPU may determine the difference in the completion timestamp (the timestamp read upon completion of packet processing) and the initial timestamp (the timestamp read prior to beginning the packet processing) and then compare the difference with the estimated period of time that the vCPU is expected to take in processing the subset of packets 310a.

It will be noted that the estimated period of time may have a different range of error for the vCPUs 312a-c as for the I/O core(s) 304. For example, as noted above, the I/O core(s) 304 may be tasked with providing a very quick and deterministic or predictable inspection of packets and providing the packets to the load balancing entity 308. Conversely, the vCPUs 312a-c may be tasked with a bit more complex of a task, but still within a range of predictability that will be disrupted if the hypervisor allocates any of the processing resources of the physical cores 314a-c during a machine loop cycle within which the vCPUs 312a-c are attempting to process a given subset of packets. In either case (e.g., the I/O core processing or the vCPU processing), any delays in processing can be determined with a high level of accuracy where those delays are due to an unexpected sharing of computing resources as a result of a misconfiguration by the hypervisor with respect to pinning the vCPUs 312a-c with presumably dedicated physical cores 314a-c.

As noted above, the specific arrangement of components is an example and not intended to be limiting to a particular embodiment. As another example implementation, a workflow may not necessarily use the I/O core and load balancing entity as shown in the illustrated example. Rather, in one or more implementations, a NIC may be positioned between a driver to both receive the burst of packets and directly load balance the packets to respective virtual cores (e.g., vCPUs). For example, the vCPUs may periodically poll a NIC resulting in queues of packets that are provided to the vCPUs. The vCPUs may then process the packets and determine whether a processing delay has occurred similar to other examples described herein.

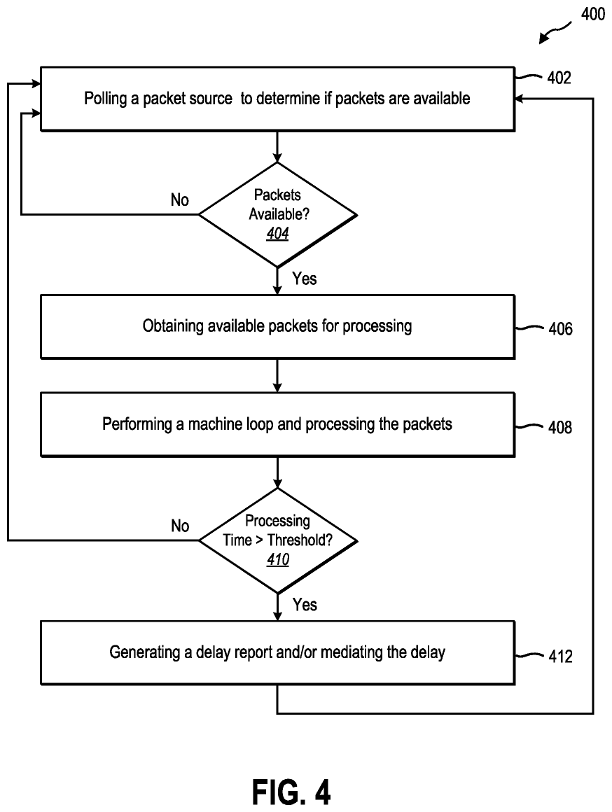

Additional detail will now be discussed in connection with an example series of acts that may be performed by any of a variety of physical cores in processing packets and determining whether a processing delay exists for a given machine loop. In particular, FIG. 4 illustrates an example series of acts 400 that may be performed by a vCPU or other software thread in receiving and processing packets in accordance with one or more embodiments described herein.

In the example shown, the vCPU may perform an act 402 of polling a source of packets to determine if one or more packets are available for processing. In one or more embodiments, this involves polling a PMD descriptor ring, a packet driver, a NIC, a load balancing entity, or any other source that can provide any available packets to a vCPU for processing. In one or more embodiments, a DPDK thread on a guest VM polls the relevant hardware source for the packets. In the example discussed above in connection with FIG. 3, the vCPUs may poll a software ring of the packets as they arrive from the I/O core(s).

As shown in FIG. 4, the vCPU may perform an act 404 of determining whether any packets are available for processing. Where the vCPU determines (or receives an indication) that no packets are available for processing, the vCPU may return to act 402 and continue polling the source of packets to determine if packet(s) are available for processing on a subsequent cycle. The vCPU may continue polling the packet source until packets are available.

In the alternative, where the vCPU determines that packets are available, the vCPU may perform an act 406 of receiving, accessing, or otherwise obtaining the packets for processing. Once obtained, the vCPU may perform an act 408 of utilizing physical core processing resources to process the packets by performing a machine loop on the obtained packets. Ideally, the number of packets will be a number close to a threshold number (e.g., a maximum threshold) of packets that the vCPU is configured to analyze for a given machine loop cycle. Nonetheless, the vCPU may process any number of packets within the maximum threshold (e.g., an upper limit) by performing the machine loop on the received set of packets.

As noted above, the vCPU may track a duration of time that it takes to process the packets and compare the tracked duration of time to an estimated duration of time associated with the number of packets of the obtained set of packets. In the example shown in FIG. 4, the vCPU may perform an act 410 of determining whether the duration of time (e.g., the tracked duration) is greater than a threshold duration of time (e.g., the expected duration of time, or the expected duration of time plus a buffer to allow a margin of error that accounts for unpredictable factors in processing a set of packets. In the event that the duration of time is not greater than the threshold of duration of time, the vCPU may return to act 402 and continue polling the source of packets for the next computing cycle.

Conversely, where the vCPU determines that the duration of time is greater than the threshold duration of time, the vCPU may perform an act 412 of generating a report and/or mediating the delay by logging, reporting, or otherwise informing an administrative entity of the delay. In one or more embodiments, the vCPU adds an instance of the delay to a log file of the VM. In one or more embodiments, the vCPU reports the delay to an entity of the server node (e.g., a hypervisor, OS, application, VM). In one or more embodiments, the delay is provided to a VM configuration management system 106 for further consideration and processing and ultimately determining whether hypervisor re-configurations are needed as well as determining a computing region of a cloud computing system that may be affected by a misconfiguration of the hypervisor(s). In one or more embodiments, the hypervisor and/or VM responds to a detected delay by reconfiguring the hypervisor to ensure that each virtual core of the VM is exclusively pinned to a corresponding physical core of the server node(s).

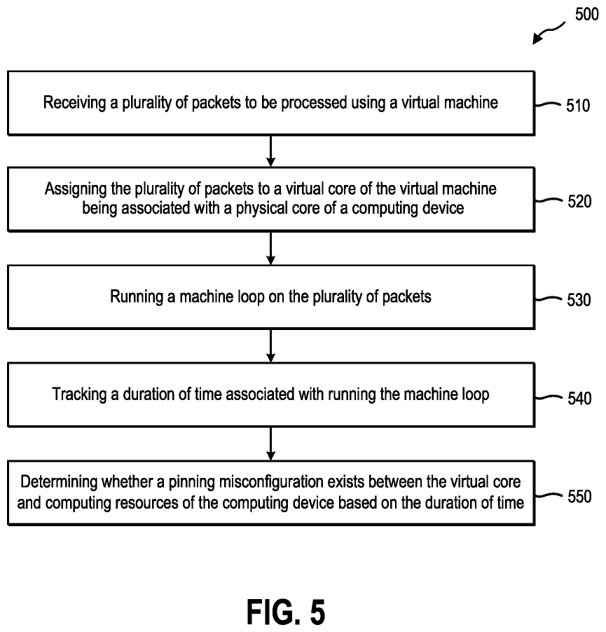

Turning now to FIG. 5, this figure illustrates example flowcharts including series of acts for detecting processing delays in a virtual core that are indicative of hypervisors misconfiguring virtual resources on a computing device. In particular, this figure illustrates an example series of acts for detecting pinning misconfigurations between virtual and physical resources on a server node or other computing device. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device (e.g., a server device) to perform the acts of FIG. 5. In still further embodiments, a system can perform the acts of FIG. 5.

FIG. 5 illustrates a series of acts 500 for detecting processing delays in a virtual core that are indicative of hypervisors misconfiguring virtual resources on a computing device. As shown in FIG. 5, the series of acts 500 includes an act 510 of receiving a plurality of packets to be processed using a virtual machine. In one or more implementations, the act 510 includes receiving a plurality of packets to be processed by computing resources allocated to a virtual machine. In one or more implementations, the virtual machine is configured to run a data plane development kit (DPDK) application in which each virtual core of the virtual machine is assumed to have access to a dedicated physical core of the computing device.

As further shown in FIG. 5, the series of acts 500 includes an act 520 of assigning the plurality of packets to a virtual core of the virtual machine being associated with a physical core of a computing device. In one or more implementations, the act 520 incudes assigning the plurality of packets to a virtual core of the virtual machine where the virtual core is associated with a physical core of the computing device from the computing resources allocated to the virtual machine.

As further shown in FIG. 5, the series of acts 500 includes an act 530 of running a machine loop on the plurality of packets. In one or more implementations, the act 530 includes running a machine loop on the plurality of packets to process the plurality of packets. As further shown in FIG. 5, the series of acts 500 includes an act 540 of tracking a duration of time associated with running the machine loop. In one or more implementations, the act 540 includes tracking a duration of time associated with running the machine loop on the plurality of packets.

As further shown in FIG. 5, the series of acts 500 includes an act 550 of determining whether a pinning misconfiguration exists between the virtual core and computing resources of the computing device based on the duration of time. In one or more implementations, the act 550 includes determining, based on a comparison of the duration of time with an estimated duration of time of processing the plurality of packets, that a pinning misconfiguration exists between the virtual core and the computing resources.

In one or more embodiments, assigning the plurality of packets to the virtual core includes assigning a number of packets to the virtual core based on an upper limit of packets that the virtual core is configured to process within an iteration of the machine loop.

In one or more embodiments, the series of acts 500 includes polling a source of the plurality of packets at polling cycles to determine availability of the plurality of packets, wherein assigning the plurality of packets to the virtual core is based on a response to the polling. The source of the packets may be any of a number of different sources. For example, in one or more implementations, polling the source of the packets includes the virtual core polling an input/output (I/O) virtual core. In one or more implementations, polling the source of the packets includes the virtual core polling a network interface controller (NIC). In one or more implementations, polling the source of the packets includes the virtual core polling a device driver of the computing device.

In one or more embodiments, the series of acts 500 includes polling, by a virtual machine, a source of packets to determine if any packets are available for processing. The series of acts 500 may further include receiving a plurality of packets being assigned to a virtual core of the virtual machine, the virtual core being associated with a physical core of the computing device from computing resources allocated to the virtual machine by the hypervisor.

In one or more embodiments, the series of acts 500 includes receiving a burst of packets at the computing device. In this example, assigning the plurality of packets to the virtual core includes causing a load balancing entity to provide a first subset of packets from the burst of packets to the virtual core while one or more additional subsets of packets from the burst of packets are assigned to one or more additional virtual cores of the virtual machine. In one or more embodiments, the load balancing entity is a network interface controller (NIC) configured to selectively deliver packets to requesting virtual cores on the virtual machine. In one or more embodiments, the load balancing entity is a load balancer that receives the burst of packets from one or more input/output (I/O) virtual cores.

In one or more embodiments, the estimated duration of time is based at least in part on a number of packets within the plurality of packets. In one or more embodiments, determining that the pinning misconfiguration exists includes comparing the duration of time with a high threshold estimate associated with a maximum number of packets that the virtual core is configured to process within a single machine loop. In one or more embodiments, the computing device is a server node hosting the virtual machine on a cloud computing system.

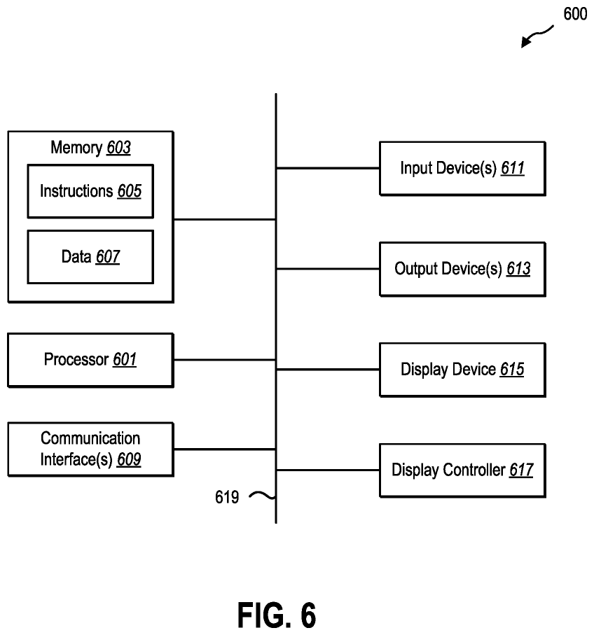

FIG. 6 illustrates certain components that may be included within a computer system 600. One or more computer systems 600 may be used to implement the various devices, components, and systems described herein.

The computer system 600 includes a processor 601. The processor 601 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used. In one or more embodiments, the computer system 600 further includes one or more graphics processing units (GPUs), which can provide processing services related to both entity classification and graph generation.

The computer system 600 also includes memory 603 in electronic communication with the processor 601. The memory 603 may be any electronic component capable of storing electronic information. For example, the memory 603 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. In a computing device having a hypervisor for managing configurations of at least one virtual machine, a method for detecting pinning misconfigurations, the method comprising:
receiving a plurality of packets to be processed by computing resources of the computing device, the computing resources including a plurality of physical cores;
assigning the plurality of packets to a virtual core of a virtual machine, the virtual core being associated with a physical core of the plurality of physical cores on the computing device;
tracking a duration of time associated with processing the plurality of packets by running a machine loop on the plurality of packets;
comparing the duration of time to an estimated duration of time of processing the plurality of packets;
determining, based on a difference between the duration of time and the estimated duration of time exceeding a threshold difference, that a pinning misconfiguration exists between the virtual core and the computing resources; and
performing a mediation action for resolving the pinning misconfiguration between the virtual core and the computing resources.

2. The method of claim 1, wherein the virtual machine is configured to run a data plane development kit (DPDK) application in which each virtual core of the virtual machine is assumed to have access to a dedicated physical core of the plurality of physical cores.

3. The method of claim 1, wherein assigning the plurality of packets to the virtual core includes assigning a number of packets to the virtual core based on an upper limit of packets that the virtual core is configured to process within an iteration of the machine loop.

4. The method of claim 1, further comprising polling a source of the plurality of packets at polling cycles to determine availability of the plurality of packets, wherein assigning the plurality of packets to the virtual core is based on a response to the polling.

5. The method of claim 1, further comprising receiving a burst of packets at the computing device, wherein the plurality of packets is a first subset of packets from the burst of packets, and wherein assigning the plurality of packets to the virtual core includes causing a load balancing entity to provide the first subset of packets from the burst of packets to the virtual core while one or more additional subsets of packets from the burst of packets are assigned to one or more additional virtual cores of the virtual machine.

6. The method of claim 5, wherein the load balancing entity is a network interface controller (NIC) configured to selectively deliver packets to requesting virtual cores on the virtual machine.

7. The method of claim 5, wherein the load balancing entity is a load balancer that receives the burst of packets from one or more input/output (I/O) virtual cores.

8. The method of claim 1, wherein the estimated duration of time is based at least in part on a number of packets within the plurality of packets.

9. The method of claim 1, wherein determining that the pinning misconfiguration exists includes comparing the duration of time with a high threshold estimate associated with a maximum number of packets that the virtual core is configured to process within a single machine loop.

10. The method of claim 1, wherein the computing device is a server node hosting the virtual machine on a cloud computing system.

11. A computing system having a hypervisor for managing configurations of at least one virtual machine, the computing system comprising:
at least one processor;
memory in electronic communication with the at least one processor; and
instructions stored in the memory, the instructions being executable by the at least one processor to:
receive a plurality of packets to be processed by computing resources of the computing device, the computing resources including a plurality of physical cores;
assign the plurality of packets to a virtual core of a virtual machine, the virtual core being associated with a physical core of the plurality of physical cores on the computing device;
track a duration of time associated with processing the plurality of packets by running a machine loop on the plurality of packets;
comparing the duration of time to an estimated duration of time of processing the plurality of packets;
determine, based on a difference between the duration of time and the estimated duration of time exceeding a threshold difference, that a pinning misconfiguration exists between the virtual core and the computing resources;
causing the hypervisor to be reconfigured to prevent pinning misconfigurations between virtual cores on the computing device and the plurality of physical cores.

12. The computing system of claim 11, wherein the virtual machine is configured to run a data plane development kit (DPDK) application in which each virtual core of the virtual machine is assumed to have access to a dedicated physical core of the plurality of physical cores.

13. The computing system of claim 11, wherein the instructions are further executable to cause the at least one processor to receive a burst of packets at the computing device, wherein assigning the plurality of packets to the virtual core includes causing a load balancing entity to provide a first subset of packets from the burst of packets to the virtual core while one or more additional subsets of packets from the burst of packets are assigned to one or more additional virtual cores of the virtual machine.

14. The computing system of claim 13,
wherein the load balancing entity is a network interface controller (NIC) configured to selectively deliver packets to requesting virtual cores on the virtual machine, and
wherein the load balancing entity is a load balancer that receives the burst of packets from one or more input/output (I/O) virtual cores.

15. The computing system of claim 11, wherein determining that the pinning misconfiguration exists includes comparing the duration of time with a high threshold estimate associated with a maximum number of packets that the virtual core is configured to process within a single machine loop.

16. The computing system of claim 15, wherein the estimated duration of time is a combined duration of time including a first duration within which the virtual core is expected to process the plurality of packets and a second duration comprising a buffer to provide a margin of error in processing the plurality of packets.

17. In a computing device having a hypervisor for managing configurations of at least one virtual machine, a method for detecting pinning misconfigurations, the method comprising:
polling, by a virtual machine, a source of packets to determine if any packets are available for processing;
receiving a plurality of packets to be processed by computing resources of a computing device, the computing resources including a plurality of physical cores, and wherein the plurality of packets are assigned to a virtual core of the virtual machine, the virtual core being associated with a physical core of the plurality of physical cores on the computing device;
tracking a duration of time associated with processing the plurality of packets by running a machine loop on the plurality of packets;
comparing the duration of time to an estimated duration of time of processing the plurality of packets;
determining, based on a difference between the duration of time and the estimated duration of time exceeding a threshold difference, that a pinning misconfiguration exists between the virtual core and the computing resources; and
performing a mediation action for resolving the pinning misconfiguration between the virtual core and the computing resources.

18. The method of claim 17, wherein the virtual machine is configured to run a data plane development kit (DPDK) application in which each virtual core of the virtual machine is assumed to have access to a dedicated physical core of the plurality of physical cores.

19. The method of claim 17, further comprising:
receiving a burst of packets at the computing device, wherein the plurality of packets is a first subset of packets from the burst of packets; and
causing a load balancing entity to provide the first subset of packets from the burst of packets to the virtual core while one or more additional subsets of packets from the burst of packets are assigned to one or more additional virtual cores of the virtual machine.

20. The method of claim 17, wherein the computing device is a server node hosting the virtual machine on a cloud computing system.
